(19) United States
(12) Patent Application Publication
(10) Pub. No.: US 2007/0011255 A1
(43) Pub. Date: Jan. 11, 2007

(54) Information processing apparatus and e-mail control method

(75) Inventor: Shuji Miyamoto, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/439,956

(22) Filed: May 25, 2006

(30) Foreign Application Priority Data
May 25, 2005 (JP) 2005-152546

(51) Int. Cl. G06F 15/16

(52) U.S. Cl. 709/206

(57) ABSTRACT

According to one embodiment, an information processing apparatus includes a receiving unit which receives an e-mail having a mail header including a sender field indicative of a sender address of the e-mail, a first destination field indicative of a destination address which designates a recipient of the e-mail, and a second destination field indicative of a carbon copy recipient address which designates a carbon copy recipient who receives a copy of the e-mail, an address extraction unit which extracts the sender address, the destination address and the carbon copy recipient address from the mail header of the received e-mail, a display unit which displays a destination candidate list indicating the extracted mail addresses, and a destination address setting unit which sets a mail address, which is selected from the destination candidate list, in a reply e-mail to the received e-mail as a destination address of the reply e-mail.

### CROSS-REFERENCE TO RELATED APPLICATIONS

This application is based upon and claims the benefit of priority from Japanese Patent Application No. 2005-152546, filed May 25, 2005, the entire contents of which are incorporated herein by reference.

### BACKGROUND

1. Field

One embodiment of the invention relates to an information processing apparatus capable of executing transmission and reception of e-mail, and an e-mail control method for use in the apparatus.

2. Description of the Related Art

In recent years, various kinds of e-mail software, which executes transmission and reception of e-mail, have been developed. The e-mail software has a “reply” function and a “forward” function.

The “reply” function is a function for supporting creation of a reply e-mail in response to a received e-mail. When a button or an icon for activating the “reply” function is clicked, a copy (or a partially processed copy) of a message, which is contained in the body of the received e-mail, is inserted into the body of the reply e-mail. Further, in the destination field (To:), the mail address that specifies the sender of the received mail, that is, the sender address appearing in the sender field (From:) of the received mail, is set.

The “forward” function is a function for forwarding a received e-mail to another person. When a button or an icon for activating the “forward” function is clicked, a copy (or a partially processed copy) of a message, which is contained in the body of the received e-mail, is inserted into the body of the forward e-mail. No address is set in the destination field (To:) or in the carbon copy recipient field (CC:) of the forward e-mail. By a manual operation, the user sets the destination address, which specifies the recipient of the forward e-mail, in the destination field (To:). In addition, by a manual operation, the user sets a carbon copy recipient address, which specifies a carbon copy recipient of a copy of the forward e-mail, in the carbon copy recipient field (CC:).

However, with these “reply” and “forward” functions, the setting of the destination address of reply e-mail may be time-consuming in some cases.

For example, assume that a person-in-charge A receives e-mail containing an inquiry from a customer E, the person-in-charge A forwards the received e-mail to persons in charge B, C and D who are familiar with the content of the inquiry, and the person-in-charge B (or C, D) directly sends to the customer E a reply mail containing an answer to the inquiry. In this case, the mail address of the customer E needs to be set in the destination field (To:) of the reply mail, and the mail addresses of the persons A, C and D need to be set in the carbon copy recipient field (CC:) of the reply mail.

In the forward mail, which is sent from the person-in-charge A to the persons in charge B, C and D, the mail addresses of the persons B, C and D are set in the destination field (To:) of the forward mail, and the mail address of the customer E is set in the carbon copy recipient field (CC:) of the forward mail.

If the person B creates a reply mail to the e-mail from the person A by using the “reply” function, the address of the person A, and not the address of the customer E, is set as the destination address of the reply mail.

On the other hand, if the person B creates a reply mail to the e-mail from the person A by using the “forward” function, no address is set in the destination address field (To:) or in the carbon address recipient address field (CC:) of the reply mail.

Even if either the “reply” function or the “forward” function is used, the person-in-charge B has to manually set the mail address of the customer E in the destination field (To:) of the reply e-mail, and the mail addresses of the persons in charge A, C and D in the carbon copy recipient field (CC:) of the reply e-mail.

Jpn. Pat. Appln. KOKAI Publication No. 2001-125844 discloses an e-mail terminal apparatus having a function of extracting e-mail addresses from the sender field (From:) and the body of a received e-mail. In this e-mail terminal apparatus, extracted mail addresses, that is, the mail address included in the sender address field (From:) of the received e-mail and the mail address included in the message in the body of the received e-mail, are used as destination address candidates of a reply mail.

In this e-mail terminal apparatus, however, a mail address, which is set in the carbon copy recipient address field (CC:) of the received mail, is not extracted. It is thus not possible to use mail addresses of carbon copy recipients, which are included in the received mail, as destination address candidates of a reply mail to the received mail.

Under the circumstances, there is a need to realize a novel function for efficiently executing destination address setting in reply mail.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing an example of the configuration of an e-mail system according to an embodiment of the invention;

FIG. 2 is an exemplary block diagram showing an example of the system configuration of a computer for use in the e-mail system according to the embodiment;

FIG. 3 is an exemplary view showing an example of the functional configuration of an e-mail program that is executed by the computer shown in FIG. 2;

FIG. 4 is an exemplary view showing an example of the functional configuration of a reply-to-carbon-copy-recipient control unit which is provided in the e-mail program that is executed by the computer shown in FIG. 2;

FIG. 5 is an exemplary view for describing an example of the operation of the reply-to-carbon-copy-recipient control unit shown in FIG. 4;

FIG. 6 is an exemplary view showing an example of an operation screen which is displayed by the e-mail program that is executed by the computer shown in FIG. 2; and

FIG. 7 is an exemplary flow chart showing an example of a series of process procedures which are executed by the computer shown in FIG. 2.

### DETAILED DESCRIPTION

Various embodiments according to the invention will be described hereinafter with reference to the accompanying drawings. In general, according to one embodiment of the invention, an information processing apparatus includes a receiving unit which receives an e-mail having a mail header including a sender field indicative of a sender address of the e-mail, a first destination field indicative of a destination address which designates a recipient of the e-mail, and a second destination field indicative of a carbon copy recipient address which designates a carbon copy recipient who receives a copy of the e-mail; an address extraction unit which extracts the sender address, the destination address and the carbon copy recipient address from the mail header of the received e-mail; a display unit which displays a destination candidate list indicating the extracted mail addresses; and a destination address setting unit which sets a mail address, which is selected from the destination candidate list, in a reply e-mail to the received e-mail as a destination address of the reply e-mail.

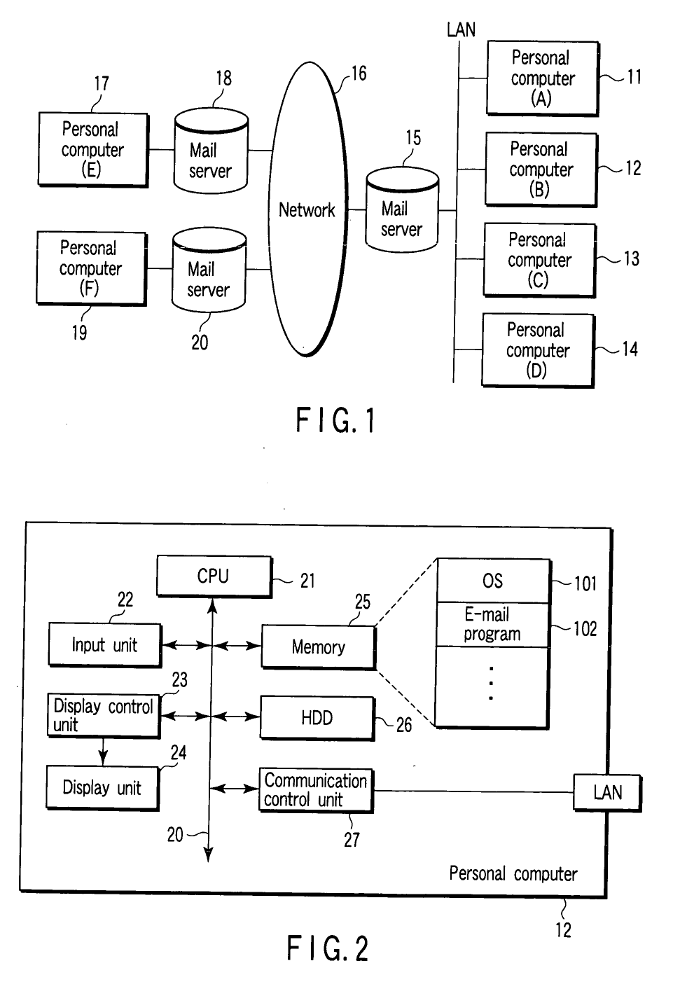

To begin with, with reference to FIG. 1 and FIG. 2, the structure of an information processing apparatus according to an embodiment of the invention is described. The information processing apparatus is an electronic apparatus capable of executing transmission and reception of e-mail, and is realized, for instance, as a personal computer 12. Needless to say, the information processing apparatus may be realized as a PDA, a mobile phone, a work station, etc.

FIG. 1 shows the configuration of the entire e-mail system. The e-mail system is a network system for forwarding e-mail. Personal computers 11 to 14 are connected to a LAN 10. Each of the personal computers 11 to 14 executes transmission/reception of e-mail to/from a mail server 15. The mail server 15 functions as a post office which is shared by the personal computers 11 to 14. Mail boxes corresponding to the personal computers 11 to 14 are provided in the mail server 15. Specifically, four mail boxes corresponding to the mail addresses of users A, B, C and D of the personal computers 11, 12, 13 and 14 are provided in the mail server 15.

At the time of transmission of e-mail, each of the personal computers 11 to 14 sends e-mail to the mail box corresponding to the personal computer at the receiving end. When e-mail is received, each of the personal computers 11 to 14 accesses its own mail box and receives the e-mail, which is addressed to itself, from the mail server 15.

The mail server 15 is connected to a network 16 such as internet or a public network. The mail server 15 executes communication with other mail servers 18 and 20 via the network 16. Thereby, forwarding of e-mail is executed, where necessary, between the mail servers 15, 18 and 20.

The mail server 18 includes a mail box corresponding to the mail address of a user E of a personal computer 17 and functions as a post office for the personal computer 17. The mail server 20 includes a mail box corresponding to the mail address of a user F of a personal computer 19 and functions as a post office for the personal computer 19. For example, e-mail addressed to the user A of the personal computer 11, which is sent from the user E of the personal computer 17, is forwarded from the mail server 18 to the mail server 15 and written in the mail box corresponding to the user A.

FIG. 2 is a block diagram showing the system configuration of the personal computer 12.

The personal computer 12 includes a CPU 21, an input unit 22, a display control unit 23, a display unit 24, a memory 25, a hard disk drive (HDD) 26, and a communication control unit 27. The CPU 21, input unit 22, display control unit 23, display unit 24, memory 25, hard disk drive (HDD) 26, and communication control unit 27 are electrically connected to a bus 20.

The CPU 21 is a processor which controls the operation of the personal computer 12. The CPU 21 executes an operating system (OS) 101 and an e-mail program 102, which are loaded from the HDD 26 into the memory 25. The e-mail program 102 is a program which executes transmission and reception of e-mail, and includes an e-mail creation function, a reply function and a forward function.

The input unit 22 is an input device such as a keyboard or a pointing device. The display control unit 23 causes the display unit 24 to display various data under the control of the CPU 21. The communication control unit 27 executes, under the control of the CPU 21, communication with other personal computers or the mail server 15 via the LAN 10.

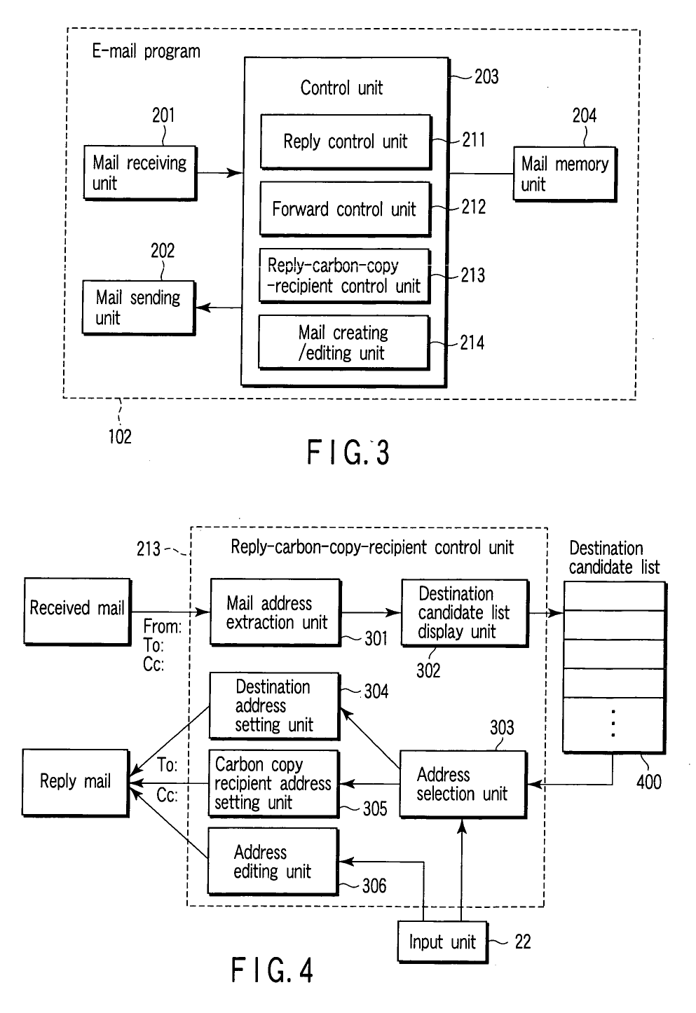

Next, referring to FIG. 3, the functional configuration of the e-mail program 102 is described.

The e-mail program 102 comprises a mail receiving unit 201, a mail sending unit 202, a control unit 203 and a mail memory unit 204.

The mail receiving unit 201 executes communication with the mail server 15 according to a protocol such as POP (Post Office Protocol), and executes a process for receiving e-mail from the mail server 15. E-mail is composed of a mail header and a body. The mail header includes a sender field (From:) which is indicative of a sender address that designates a sender of the e-mail, a first destination field (To:) which is indicative of a destination address that designates a recipient of the e-mail, and a second destination field (CC:) which is indicative of a carbon copy recipient address that designates a carbon copy recipient who receives a copy of the e-mail. The first destination field (To:) may simply be referred to as “destination field”, and the second destination field (CC:) may be referred to as “carbon copy recipient field”.

E-mail, in which the mail address of the user B of the personal computer 12 is set in the destination field (To: or CC:), is written in the mail box corresponding to the mail address of the user B of the personal computer 12. The mail receiving unit 201 accesses the mail box corresponding to the mail address of the user B and receives e-mail in which the mail address of the user B is set in the destination field (To: or CC:).

The mail sending unit 202 sends to the mail server 15 an e-mail which is newly created by the control unit 203, or an e-mail (reply e-mail, forward e-mail) which is obtained by editing a received e-mail. The mail sending unit 202 executes a process of sending e-mail according to a protocol such as SMTP (Simple Mail Transfer Protocol).

The control unit 203 includes a reply control unit 211, a forward control unit 212, a reply-to-carbon-copy-recipient control unit 213 and a mail creating/editing unit 214.

The reply control unit 211 executes a “reply” function. The “reply” function, as described above, is a function for supporting creation of a reply e-mail to a received e-mail. When a button or an icon for activating the “reply” function is clicked, a copy (or a partially processed copy) of a message, which is contained in the body of the received e-mail, is inserted into the body of the reply e-mail. Further, in the destination field (To:) of the reply e-mail, the sender address appearing in the sender field (From:) of the received mail is set. Thereby, the sender address in the sender field (From:) of the received mail is set as the destination address of the reply e-mail.

The forward control unit 212 executes a “forward” function. The “forward” function, as described above, is a function for forwarding a received e-mail to another person. When a button or an icon for activating the “forward” function is clicked, a copy (or a partially processed copy) of a message, which is contained in the body of the received e-mail, is inserted into the body of the forward e-mail. No address is set in the destination address field (To:) or in the carbon copy recipient address field (CC:) of the forward e-mail.

The reply-to-carbon-copy-recipient control unit 213 executes a “reply-to-carbon-copy-recipient” function. The “reply-to-carbon-copy-recipient” function is a function for supporting creation of a reply mail which is addressed to a carbon copy recipient who is set in the carbon copy recipient field (CC:) of a received e-mail. When a button or an icon for activating the “reply-to-carbon-copy-recipient” function is clicked, a copy (or a partially processed copy) of a message, which is contained in the body of the received e-mail, is inserted into the body of the reply e-mail. In addition, the reply-to-carbon-copy-recipient control unit 213 acquires a sender address, a destination address and a carbon copy recipient address from the sender field (From:), destination field (To:) and carbon copy recipient field (CC:), which are contained in the mail header of the received e-mail, and displays a list of the acquired mail addresses as a destination candidate list. When one of the mail addresses in the destination candidate list is selected by the user B, the reply-to-carbon-copy-recipient control unit 213 sets the selected mail address in the reply e-mail as the destination address of the reply e-mail. In short, the selected mail address is set in the destination field (To:) of the reply e-mail.

The mail creating/editing unit 214 executes a process of newly creating an e-mail which is to be sent, and a process of editing a reply e-mail/forward e-mail.

The mail memory unit 204 stores e-mail, which is received by the mail receiving unit 201, in the memory 25, HDD 26 or the like.

Next, referring to FIG. 4, the functional configuration of the reply-to-carbon-copy-recipient control unit 213 is described.

The reply-to-carbon-copy-recipient control unit 213 comprises a mail address extraction unit 301, a destination candidate list display unit 302, an address selection unit 303, a destination address setting unit 304, a carbon copy recipient address setting unit 305, and an address editing unit 306.

The mail address extraction unit 301 extracts a sender address, a destination address and a carbon copy recipient address from the sender field (From:), destination field (To:) and carbon copy recipient field (CC:) which are included in the mail header of received e-mail. The destination candidate list display unit 302 creates a destination candidate list 400 which indicates a table of all extracted mail addresses, and displays the destination candidate list 400 on the display unit 24. In this case, the mail address of the user B is excluded from the table of mail addresses which are displayed on the destination candidate list 400. The address selection unit 303 selects one of the mail addresses on the destination candidate list 400 in accordance with the operation of the input unit 22 by the user B.

The destination address setting unit 304 sets the mail address, which is selected by the address selection unit 303, in the destination field (To:) of reply e-mail to the received e-mail. The carbon copy recipient address setting unit 305 sets all mail addresses, which are included in the table of mail addresses displayed on the destination candidate list 400 and are other than the mail address selected by the address selection unit 303, in the carbon copy recipient field (CC:) of the reply e-mail to the received e-mail.

The address editing unit 306 edits the contents of the destination field (To:) and carbon copy recipient field (CC:) of the reply e-mail, in accordance with the operation of the input unit 22 by the user B.

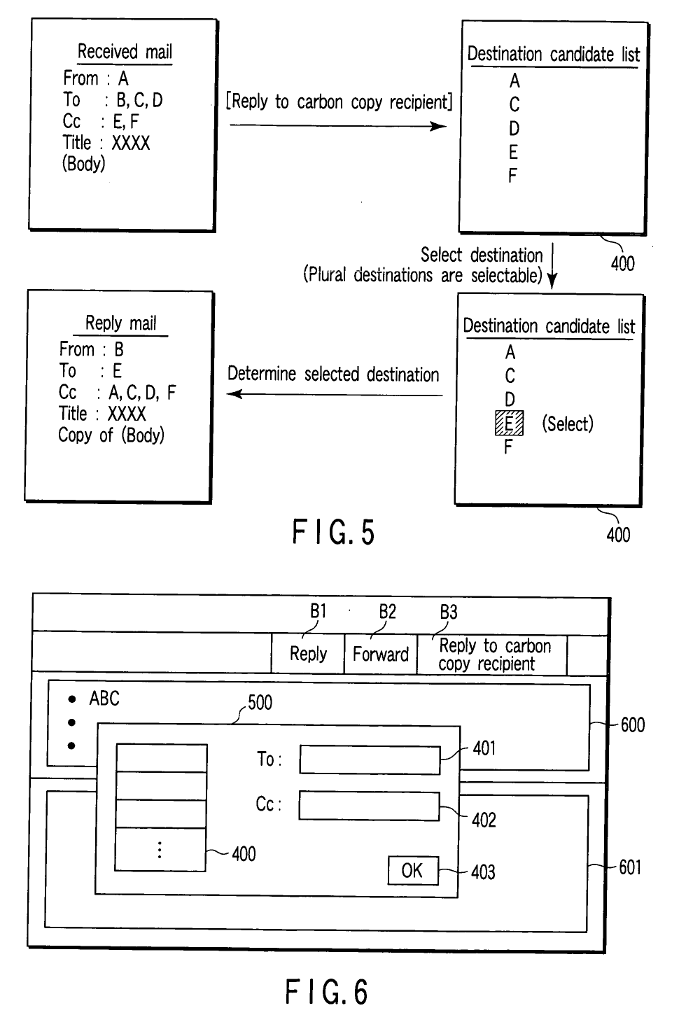

Next, with reference to FIG. 5, the operation of the reply-to-carbon-copy-recipient control unit 213 is described.

Now assume a case in which the person-in-charge A, who has received an inquiry e-mail from the customer E, forwards the e-mail to the persons in charge, B, C and D, who are familiar with the content of the inquiry, and the person B directly sends an answer mail to the customer E. In the e-mail that the person B receives from the person A, for example, the mail address of the person-in-charge A is set in the sender field (From:), the mail addresses of the persons B, C and D are set in the destination field (To:), and the mail address of the customer E and the mail address of another person-in-charge F are set in the carbon copy recipient field (CC:).

When a button or an icon for activating the “reply-to-carbon-copy-recipient” function is clicked, the reply-to-carbon-copy-recipient control unit 213 extracts from the received e-mail the mail address of the sender A, the mail addresses of the recipients C and D and the mail addresses of the carbon copy recipients E and F, and displays the destination candidate list 400 indicating the table of mail addresses of the persons A, C, D, E and F. The user B selects a mail address (plural mail addresses are selectable) which is to be set as the destination address of a reply e-mail to the received e-mail.

Assume now that the mail address of E has been selected. The reply-to-carbon-copy-recipient control unit 213 sets the mail address of B in the sender field (From:) of the reply e-mail, and sets the mail address of E in the destination field (To:) of the reply e-mail. Further, the reply-to-carbon-copy-recipient control unit 213 sets the mail addresses of non-selected A, C, D and F in the carbon copy recipient field (CC:) of the reply e-mail.

FIG. 6 shows an example of the operation screen which is displayed by the e-mail program 102.

The operation screen displays a received mail display window 600 which indicates a list of received e-mails, and an edit window 601. The edit window 601 is used in order to display the content of received e-mail or to create/edit e-mail to be sent. On the menu bar of the operation screen, a “reply” button B1, a “forward” button B2 and a “reply-to-carbon-copy-recipient” button B3 are arranged. If the “reply” button B1 is clicked, the “reply” function is executed. If the “forward” button B2 is clicked, the “forward” function is executed.

If the “reply-to-carbon-copy-recipient” button B3 is clicked, the “reply-to-carbon-copy-recipient” function is executed. In this case, to begin with, a destination setting screen 500 is displayed. On the destination setting screen 500, the destination candidate list 400, a destination input field 401, a carbon copy recipient input field 402, and an “OK” button 403 are displayed. If a mail address is selected by the user B from the destination candidate list 400, the selected mail address is set in the destination input field 401. In addition, all the other non-selected mail addresses are set in the carbon copy recipient input field 402. It is also possible to select a plurality of mail addresses from the destination candidate list 400. In this case, the selected plural mail addresses are set in the destination input field 401, and the other non-selected mail addresses are set in the carbon copy recipient input field 402. If the “OK” button 403 is clicked, the destination addresses and carbon copy recipient addresses of reply e-mail are set. In this case, each mail address in the destination input field 401 is set in the destination field (To:) of the reply e-mail, and each mail address in the carbon copy recipient input field 402 is set in the carbon copy recipient field (CC:) of the reply e-mail.

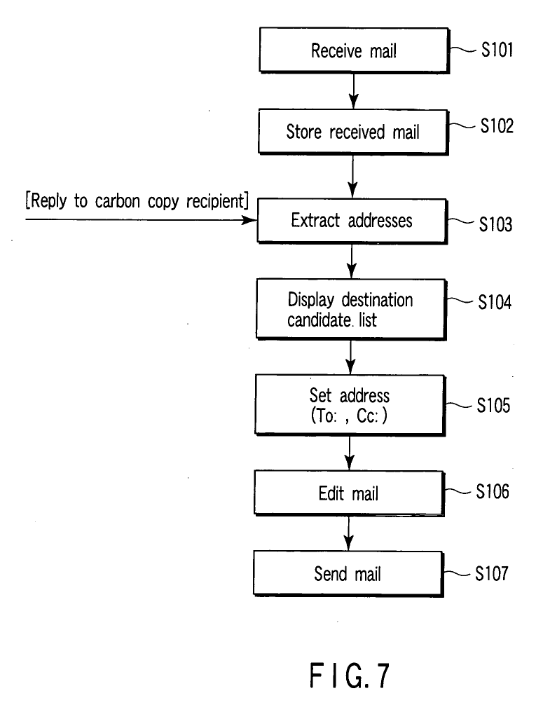

Next, referring to a flow chart of FIG. 7, a series of process procedures which are executed by the e-mail program 102 are described.

The e-mail program 102 receives e-mail from the mail box corresponding to the mail address of B (block S101). The e-mail program 102 stores the received e-mail in the memory 25, for instance (block S102).

A list of received e-mails stored in the memory 25 is displayed on the received mail display window 600. When the user B clicks the “reply-to-carbon-copy-recipient” button B3 in the state in which an arbitrary received e-mail is selected on the received mail display window 600, the e-mail program 102 extracts the sender address, destination address and carbon copy recipient address from the selected received e-mail (block S103).

The e-mail program 102 displays the destination candidate list 400 which indicates a table of extracted mail addresses (block S104). The mail address of the user B is not displayed on the destination candidate list 400. If an arbitrary mail address in the destination candidate list 400 is selected by the user, the e-mail program 102 sets the selected mail address as the destination address of a reply e-mail to the received e-mail (block S105). In block 105, the e-mail program 102 sets the selected mail address in the destination field (To:) of the reply e-mail, and sets all the other non-selected mail addresses in the carbon copy recipient field (CC:) of the reply e-mail. Further, the e-mail program 102 sets the mail address of B in the sender field (From:) of the reply e-mail.

Subsequently, the e-mail program 102 inserts a copy of the body of the received e-mail into the body of the reply e-mail, and displays the body of the reply e-mail on the edit window 601 (block 106). The user can edit the body of the reply e-mail on the edit window 601. Then, the e-mail program 102 sends the reply e-mail to the mail server 15 (block S107). The reply e-mail is sent to the mail box corresponding to the recipient who is designated by the destination address of the reply e-mail. In addition, the reply e-mail is also sent to the mail boxes corresponding to the carbon copy recipients who are designated by the carbon copy recipient addresses of the reply e-mail.

As has been described above, in the present embodiment, the list, which indicates the sender address, destination address and carbon copy recipient address included in received e-mail, is displayed, and a mail address selected from the list is set as the destination address of reply e-mail. Thereby, it becomes possible to easily create reply e-mail to persons concerned, other than the sender of the received e-mail.

The e-mail control process of the present embodiment is all realized by a computer program. Thus, if the computer program is simply installed in an ordinary computer through a computer-readable memory medium, the same advantages as in the present embodiment can easily be realized. In addition, this computer program can be executed not only by a personal computer, but also by various electronic devices which incorporate processors.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a receiving unit which receives an e-mail having a mail header including a sender field indicative of a sender address of the e-mail, a first destination field indicative of a destination address which designates a recipient of the e-mail, and a second destination field indicative of a carbon copy recipient address which designates a carbon copy recipient who receives a copy of the e-mail;
a memory device which stores the received e-mail;
an address extraction unit which extracts the sender address, the destination address and the carbon copy recipient address from the mail header of the received e-mail which is stored in the memory device;
a display unit which displays a destination candidate list indicating a table of mail addresses including the sender address, the destination address and the carbon copy recipient address, which are extracted by the address extraction unit; and
a destination address setting unit which sets a mail address, which is selected from the table of the mail addresses, in a reply e-mail to the received e-mail as a destination address of the reply e-mail.

2. The information processing apparatus according to claim 1, further comprising a carbon copy recipient address setting unit which sets all mail addresses, which are included in the table of the mail addresses and are other than the selected mail address, in the reply e-mail as carbon copy recipient addresses of the reply e-mail.

3. The information processing apparatus according to claim 1, wherein the destination address setting unit includes means for selecting an address from the table of the addresses in accordance with an operation of an input device which is provided in the information processing apparatus, and means for setting the address selected by the address selection means in the reply e-mail as the destination address of the reply e-mail.

4. The information processing apparatus according to claim 1, wherein the reply e-mail has a mail header including a sender field indicative of a sender address of the reply e-mail, a first destination field indicative of a destination address which designates a recipient of the reply e-mail, and a second destination field indicative of a carbon copy recipient address which designates a carbon copy recipient who receives a copy of the reply e-mail, and
the destination address setting unit sets the selected mail address in the first destination field of the reply e-mail.

5. An e-mail control method which executes transmission and reception of e-mail, comprising:
receiving an e-mail having a mail header including a sender field indicative of a sender address of the e-mail, a first destination field indicative of a destination address which designates a recipient of the e-mail, and a second destination field indicative of a carbon copy recipient address which designates a carbon copy recipient who receives a copy of the e-mail;
storing the received e-mail in a memory device;
extracting the sender address, the destination address and the carbon copy recipient address from the mail header of the received e-mail which is stored in the memory device;
displaying on a display device a destination candidate list indicating a table of mail addresses including the sender address, the destination address and the carbon copy recipient address, which are extracted; and
setting a mail address, which is selected from the table of the mail addresses, in a reply e-mail to the received e-mail as a destination address of the reply e-mail.

6. The e-mail control method according to claim 5, further comprising setting all mail addresses, which are included in the table of the mail addresses and are other than the selected mail address, in the reply e-mail as carbon copy recipient addresses of the reply e-mail.

7. The e-mail control method according to claim 5, wherein said setting the selected mail address in the reply e-mail as the destination address of the reply e-mail includes selecting a mail address from the table of the mail addresses in accordance with an operation of an input device, and setting the selected address in the reply e-mail as the destination address of the reply e-mail.

8. The e-mail control method according to claim 5, wherein the reply e-mail has a mail header including a sender field indicative of a sender address of the reply e-mail, a first destination field indicative of a destination address which designates a recipient of the reply e-mail, and a second destination field indicative of a carbon copy recipient address which designates a carbon copy recipient who receives a copy of the reply e-mail, and
said setting the selected mail address in the reply e-mail as the destination address of the reply e-mail includes setting the selected mail address in the first destination field of the reply e-mail.

9. A program which is stored in a computer-readable medium and causes a computer to execute transmission and reception of e-mail, comprising:
causing the computer to execute a process of receiving an e-mail having a mail header including a sender field indicative of a sender address of the e-mail, a first destination field indicative of a destination address which designates a recipient of the e-mail, and a second destination field indicative of a carbon copy recipient address which designates a carbon copy recipient who receives a copy of the e-mail;
causing the computer to execute a process of storing the received e-mail in a memory device of the computer;
causing the computer to execute an address extraction process of extracting the sender address, the destination address and the carbon copy recipient address from the mail header of the received e-mail which is stored in the memory device;
causing the computer to execute a process of displaying on a display device of the computer a destination candidate list indicating a table of mail addresses including the sender address, the destination address and the carbon copy recipient address, which are extracted by the address extraction process; and
causing the computer to execute a destination address setting process of setting a mail address, which is selected from the table of the mail addresses, in a reply e-mail to the received e-mail as a destination address of the reply e-mail.

10. The program according to claim 9, further comprising causing the computer to execute a carbon copy recipient address setting process of setting all mail addresses, which are included in the table of the mail addresses and are other than the selected mail address, in the reply e-mail as carbon copy recipient addresses of the reply e-mail.

11. The program according to claim 9, wherein the destination address setting process includes causing the computer to execute an address selection process of selecting a mail address from the table of the mail addresses in accordance with an operation of an input device of the computer, and causing the computer to execute a process of setting the selected mail address in the reply e-mail as the destination address of the reply e-mail.

12. The program according to claim 9, wherein the reply e-mail has a mail header including a sender field indicative of a sender address of the reply e-mail, a first destination field indicative of a destination address which designates a recipient of the reply e-mail, and a second destination field indicative of a carbon copy recipient address which designates a carbon copy recipient who receives a copy of the reply e-mail, and
the destination address setting process includes causing the computer to execute a process of setting the selected mail address in the first destination field of the reply e-mail.
